(19) United States
(12) Patent Application Publication
(10) Pub. No.: US 2011/0198884 A1
(43) Pub. Date: Aug. 18, 2011

(54) MULTIPLE USAGES BUS

(76) Inventor: Mohamed Ahmed Gad Elkariem, Alexandrea (EG)

(21) Appl. No.: 13/124,323

(22) PCT Filed: Oct. 14, 2009
(86) PCT No.: PCT/EG09/00026

§ 371 Date: Apr. 14, 2011

(30) Foreign Application Priority Data
Oct. 14, 2008 (EG) 2008101687

(51) Int. Cl. B60N 2/36; B60J 5/04; B60N 2/20

(52) U.S. Cl. 296/178; 297/15

(57) ABSTRACT

Multiple Usages Bus is a transportation mean, by which Enterprises can reduce cost of transportation of its employees, goods, tools and equipment.

Multiple Usages Bus uses mechanical means of cascading seats that been drawn into luggage zone by folding plates supported at floor of passengers zone, mechanical means to lower and fold cascading seats into luggage zone.

Elevated doors permit easy entrance of goods, tools and equipment into passengers' zone, maintaining the ability of transporting passengers, goods, equipment and tools separately or as whole.

Eventually, usage of such a bus leads to increase the cost of purchasing of transportation means, cost of transportation of goods, cost of hiring drivers and traffic jam occurrence.

### TECHNICAL FIELD

Passengers and cargos mass transportation

### BACKGROUND ART

The need to mass transportation of passengers has been satisfied by buses and coaches. Also the need to transport goods has been satisfied by heavy loading trucks. Large Enterprises that deal with transportation of its employees and products ought to have 2 fleets one for passengers and the other for product. Leading to the increase of the cost of transportation because of having the mentioned 2 fleets.

Also Construction Enterprises that deals with transportation of workers and their tools and equipment used to transport them separately, buses for workers and heavy loading trucks for equipment, tools and products.

### DISCLOSURE OF INVENTION

To minimize cost of transportation, multiple usages Bus has the ability to transport passengers, tools, equipment and goods or passengers and their tools, equipment and products at the same time.

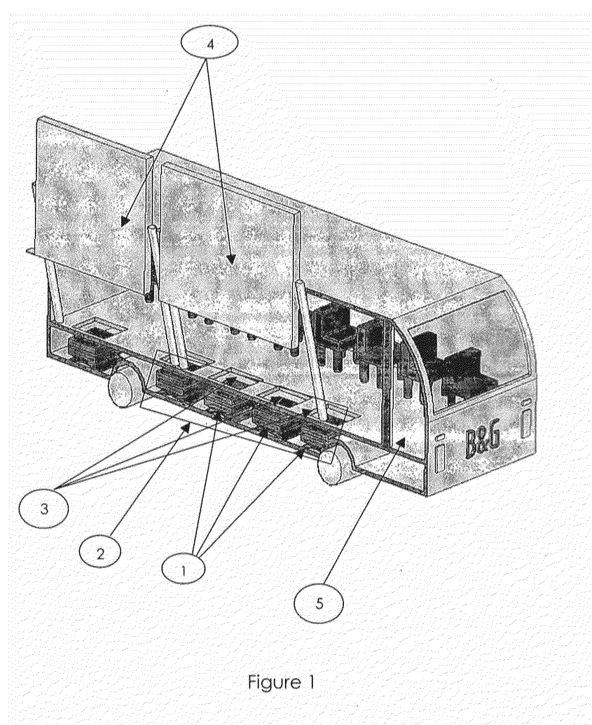

As illustrated in FIG. 1, cascading seats 1 are provided. They can be dragged into luggage zone 2 by means of folding plates 3. Elevating doors 4 permits easy entrance of goods, tools and equipment into passenger's zone. Elevating doors geometry is altered according to shape and size of Bus. At the same time ordinary entrance door 5 permits easy entrance of passengers.

### BRIEF DESCRIPTION OF DRAWING

1. FIG. 1
Cascading seats 1
Luggage zone 2
Folding plates 3
Elevating doors 4
Entrance door 5

1. Multiple Usages Bus, used for transportation of Passengers, goods, equipment and tools uses mechanical means to cascade and fold seats into luggage zone to permit transporting of any of the mentioned entities separately or as a whole.

2. According to claim 1, folding plates supported at floor of bus used to easy dragging of folding seats into luggage zone.

3. According to claim 1, elevated doors used for easy entrance of goods, tools and equipment into passengers' zone.

4. According to claim 2, elevated doors used for easy entrance of goods, tools and equipment into passengers' zone.
